(19) United States
(12) Patent Application Publication
(10) Pub. No.: US 2025/0179615 A1
(43) Pub. Date: Jun. 5, 2025

(54) NI-BASED ALLOY POWDER FOR ADDITIVE MANUFACTURING, ADDITIVELY MANUFACTURED PRODUCT, AND METHOD FOR MANUFACTURING ADDITIVELY MANUFACTURED PRODUCT

(71) Applicant: Proterial, Ltd., Tokyo (JP)

(72) Inventors: Jue Wang, Tokyo (JP); Kinya AOTA, Tokyo (JP); Kousuke KUWABARA, Tokyo (JP); Yuzo DAIGO, Tokyo (JP)

(73) Assignee: Proterial, Ltd., Tokyo (JP)

(21) Appl. No.: 18/843,694

(22) PCT Filed: Mar. 1, 2023
(86) PCT No.: PCT/JP2023/007547

§ 371 Date: Sep. 3, 2024

(30) Foreign Application Priority Data
Mar. 4, 2022 (JP) 2022-033269

(51) Int. Cl. C22C 19/05; B33Y 10/00; B33Y 70/00

(52) U.S. Cl. CPC C22C 19/058; B33Y 10/00; B33Y 70/00

(57) ABSTRACT

A Ni-based alloy powder for additive manufacturing contains, in terms of % by mass, 3.5% to 5.5% of Al, 0.8% to 4.0% of Cr, 0.02% to 0.06% of C, 1.0% to 1.8% of Si, 1.5% or less of Mn, and 0.001% to 0.050% of O, and a balance consisting of Ni and inevitable impurities, in which the content of Zr in the inevitable impurities is limited to 0.01% or less.

### TECHNICAL FIELD

The disclosure relates to a Ni-based alloy powder for additive manufacturing (hereinafter sometimes referred to as Ni-based alloy powder) suitable for additive manufacturing, an additively manufactured product, and a method for manufacturing an additively manufactured product. For example, the disclosure relates to a member or component used in an oxidation furnace for semiconductor manufacturing or a sintering furnace for electronic components.

### RELATED ART

In general, in a member or component installed in a furnace used as an oxidation furnace for semiconductor manufacturing or a sintering furnace for electronic components, in order to prevent mixing of oxide scale generated from the member or component into a product, Ni-based alloys having excellent high-temperature oxidation resistance are used. As an example of such a Ni-based alloy having excellent high-temperature oxidation resistance, for example, the following Ni-based alloy having excellent high-temperature oxidation resistance has been proposed, as shown in Patent Document 1. The Ni-based alloy contains, in terms of % by mass (hereinafter “%” indicates “% by mass”), 3.6% to 4.4% of Al, and further contains one or two or more of 0.1% to 2.5% of Si, 0.8% to 4.0% of Cr, and 0.1% to 1.5% of Mn, if necessary. The balance consists of Ni and inevitable impurities, and the Ni-based alloy may be used as a fin or a tube for a high temperature heat exchanger.

Patent Document 2 has proposed a Ni-based alloy having excellent hot forgeability and high-temperature oxidation resistance. The Ni-based alloy contains 2.0% to 5.0% of Al, 0.1% to 2.5% of Si, 0.8% to 4.0% of Cr, 0.1% to 1.5% of M n, 0.001% to 0.01% of B, 0.001% to 0.1% of Zr, and the balance consisting of Ni and inevitable impurities.

### PRIOR-ART DOCUMENTS

### Patent Documents

Patent Document 1: Japanese Patent Laid-open No. 2003-262491
Patent Document 2: Japanese Patent Laid-open No. 2014-080675

### SUMMARY OF THE INVENTION

### Problems to be Solved by the Invention

However, in recent years, in applications such as members or components of manufacturing furnaces for semiconductor products or electronic components, there is a demand not only for excellent high-temperature oxidation resistance but also for achieving a complex shape of a gas flow path or the like within the members or components. It is known that an additive manufacturing method using alloy powder is suitable as a means to achieve this complex shape. Here, while the Ni-based alloys described in Patent Documents 1 and 2 have excellent high-temperature oxidation resistance, they have high weld cracking susceptibility (hereinafter sometimes referred to as cracking susceptibility) due to a high Al content. The additive manufacturing method involves a process in which melting and solidification of individual powder particles are repeated. Since this process is equivalent to welding at the micro level, it can be easily inferred that applying the Ni-based alloys described in Patent Documents 1 and 2 that have high weld cracking susceptibility to the additive manufacturing method would likely result in cracking. If the high-temperature oxidation resistance is poor, defects caused by oxides become apparent.

In view of the above, the disclosure aims to provide a Ni-based alloy powder suitable for manufacturing an additively manufactured product having few cracks or defects and having excellent high-temperature oxidation resistance, as well as an additively manufactured product using the Ni-based alloy powder and a method for manufacturing the additively manufactured product.

### Means for Solving the Problems

The disclosure provides a Ni-based alloy powder for additive manufacturing, containing, in terms of % by mass, 3.5% to 5.5% of Al, 0.8% to 4.0% of Cr, 0.02% to 0.06% of C, 1.0% to 1.8% of Si, 1.5% or less of Mn, and 0.001% to 0.050% of O, and a balance consisting of Ni and inevitable impurities, in which the content of Zr in the inevitable impurities is limited to 0.01% or less.

Preferably, the Ni-based alloy powder for additive manufacturing contains 3.6% to 5.0% of Al, 1.5% to 3.0% of Cr, 0.03% to 0.05% of C, 1.2% to 1.5% of Si, 0.2% to 1.0% of Mn, and 0.008% to 0.030% of O.

Preferably, the Ni-based alloy powder for additive manufacturing has a Vickers hardness ranging from 160 HV to 220 HV.

Preferably, in the Ni-based alloy powder for additive manufacturing, in a cumulative distribution curve indicating a relationship between particle size and volume cumulative from a small particle size side obtained by a laser diffraction method, a particle size d10 of the powder corresponding to a cumulative frequency of 10 volume % is 10 μm or more and 25 μm or less, a particle size d50 corresponding to a cumulative frequency of 50 volume % is 25 μm or more and 40 μm or less, and a particle size d90 corresponding to a cumulative frequency of 90 volume % is 45 μm or more and 60 μm or less.

Preferably, a uniformity represented by (d90−d10)/d50 ranges from 0.8 to 1.2.

Preferably, in the Ni-based alloy powder for additive manufacturing, an angle of repose measured in accordance with JIS R 9301-2-2 is 40 degrees or less.

The disclosure provides a method for manufacturing an additively manufactured product, including an additive manufacturing process that forms an additively manufactured product using Ni-based alloy powder. The Ni-based alloy powder contains, in terms of % by mass, 3.5% to 5.5% of Al, 0.8% to 4.0% of Cr, 0.02% to 0.06% of C, 1.0% to 1.8% of Si, 1.5% or less of M n, and 0.001% to 0.050% of O, and a balance consisting of Ni and inevitable impurities, in which the content of Zr in the inevitable impurities is limited to 0.01% or less.

The disclosure provides an additively manufactured product containing, in terms of % by mass, 3.5% to 5.5% of Al, 0.8% to 4.0% of Cr, 0.02% to 0.06% of C, 1.0% to 1.8% of Si, 1.5% or less of Mn, and 0.001% to 0.050% of O, and a balance consisting of Ni and inevitable impurities, in which the content of Zr in the inevitable impurities is limited to 0.01% or less. The additively manufactured product has a defect rate of 0.1% or less and an oxidation amount per unit area of 0.005 mg/mm² or less, the oxidation amount per unit area being obtained by an oxidation test conducted for 950 hours in an atmospheric furnace at 800° C. and being represented by [mass loss before and after oxidation test]/[surface area before oxidation test].

Preferably, the additively manufactured product has a Vickers hardness ranging from 210 HV to 300 HV.

### Effects of the Invention

The Ni-based alloy powder of the disclosure is alloy powder for additive manufacturing which has excellent high-temperature oxidation resistance, has low weld cracking susceptibility, and is suitable for defect suppression. In the case of manufacturing a member or component for a manufacturing device for semiconductor or electronic components by an additive manufacturing method using this Ni-based alloy powder, it is possible to obtain an additively manufactured product having few cracks or defects and having excellent high-temperature oxidation resistance, as well as a member or component composed of the additively manufactured product.

### BRIEF DESCRIPTION OF THE DRAWINGS

FIG. 1 illustrates a result of an oxidation test on an additively manufactured product according to examples and comparative examples of the disclosure.

### DESCRIPTION OF THE EMBODIMENTS

### [Ni-Based Alloy Powder]

The present inventors conducted intensive studies on alloy composition and additive manufacturing methods in order to develop a Ni-based alloy powder for additive manufacturing which has excellent high-temperature oxidation resistance and additive manufacturability. As a result, it was discovered that the following Ni-based alloy powder has excellent properties in high-temperature oxidation resistance and additive manufacturability that enables manufacturing with few cracks or defects. The Ni-based alloy powder contains, in terms of % by mass, 3.5% to 5.5% of Al, 0.8% to 4.0% of Cr, 0.02% to 0.06% of C, 1.0% to 3.0% of Si, 1.5% or less of Mn, and 0.001% to 0.050% of O, and a balance consisting of Ni and inevitable impurities, in which the content of Zr in the inevitable impurities is limited to 0.01% or less.

Reasons for limiting the numerical values of each component element in the alloy composition of the Ni-based alloy powder of the disclosure will be described hereinafter in detail. After that, a method for manufacturing alloy powder and an additively manufactured product will be described. In the present specification, a numerical range expressed using “to” includes the numerical values before and after “to” as a lower limit and an upper limit, respectively. The upper limits and the lower limits described in a stepwise manner can be arbitrarily combined. “%” should be read as “% by mass”.

### (Al: 3.5% to 5.5%)

Al forms an alumina coating film on a surface of an additively manufactured product, and functions to improve the high-temperature oxidation resistance and reduce the generation of oxide scale. Al is added to the Ni-based alloy powder since it forms a passive film of an oxide on a surface layer and functions to prevent further oxidation of the Ni-based alloy powder. To ensure sufficient high-temperature oxidation resistance, a lower limit of the Al content is 3.5%. On the other hand, if the Al content is excessively high, fine cracks are likely to occur during additive manufacturing involving repeated local melting and solidification. Thus, an upper limit of the Al content is 5.5%. The Al content is preferably 3.6% to 5.0%, and more preferably 3.7% to 4.1%.

### (Cr: 0.8% to 4.0%)

Cr is an element effective for improving the high-temperature oxidation resistance by stabilizing the alumina coating film. To ensure sufficient high-temperature oxidation resistance, a lower limit of the Cr content is 0.8%. On the other hand, if the Cr content is excessively high, formation of the alumina coating film is inhibited. Thus, an upper limit of the Cr content is 4.0%. The Cr content is preferably 1.5% to 3.0%, and more preferably 1.9% to 2.1%.

### (C: 0.02% to 0.06%)

C has effects of reducing the cracking susceptibility, preventing the occurrence of shrinkage cavities during a solidification process, and improving tensile strength. To sufficiently reduce the cracking susceptibility, a lower limit of the C content is 0.02%. On the other hand, if the C content is excessively high, Cr carbides are formed and corrosion resistance deteriorates. Thus, an upper limit of the C content is 0.06%. The C content is preferably 0.03% to 0.05%, and more preferably 0.035% to 0.04%.

### (O: 0.001% to 0.050%)

In a gas atomization process during the manufacture of the Ni-based alloy powder, O forms an extremely thin and strong oxide film on the powder surface by instantly bonding mainly with Al and has an effect of suppressing further oxidation. To ensure sufficient high-temperature oxidation resistance, a lower limit of the O content is 0.001%. On the other hand, if the O content is excessively high, the oxide film formed on the powder surface becomes apparent as a defect during additive manufacturing. Thus, an upper limit of the O content is 0.050%. The O content is preferably 0.008% to 0.030%, and more preferably 0.010% to 0.015%.

The content of C and O can be controlled, for example, by dissolution in vacuum and controlling the atmosphere using argon gas atomization.

(Zr: 0.01% or less)

Zr is an impurity that is inevitably mixed in during the manufacture of the Ni-based alloy powder. If the Zr content is high, an oxide is formed and the formation of the alumina coating film is inhibited. Furthermore, due to segregation at grain boundaries, fine cracks are likely to occur from the grain boundaries. From the viewpoint of avoiding these issues, Zr is particularly limited. The Zr content is aimed at 0% and an upper limit thereof is 0.01%. The Zr content is preferably 0.001% or less, and more preferably 0.0001% or less.

### (Si: 1.0% to 1.8%)

Like Cr, Si functions to improve the high-temperature oxidation resistance by stabilizing the alumina coating film formed on the additively manufactured product. To ensure sufficient high-temperature oxidation resistance, a lower limit of the Si content is 1.0%. On the other hand, if the Si content is excessively high, shrinkage cavities are likely to occur during solidification in the process of repeated melting and solidification of individual Ni-based alloy powder particles. Thus, an upper limit of the Si content is 1.8%. The Si content is preferably 1.2% to 1.6%, and more preferably 1.3% to 1.5%.

(Mn: 1.5% or less)

Mn functions to suppress solidification cracking that may be increased by the inclusion of Al. For example, in the case where an additive manufacturing speed is increased, heat input increases and solidification cracking is likely to occur. Thus, the amount of Mn added is preferably adjusted according to the additive manufacturing speed. By having a Mn content of more than 0%, the aforementioned function can be demonstrated. Furthermore, to effectively demonstrate the function, the Min content is preferably 0.1% or more. On the other hand, if the Mn content exceeds 1.5%, the high-temperature oxidation resistance deteriorates. Hence, the M n content is set to 1.5% or less. The Mn content is preferably 0.2% to 1.0%, and more preferably 0.4% to 0.6%.

### (Balance Ni and Inevitable Impurities)

It is preferable if a total content of the inevitable impurities is, for example, 1.0% or less. The content of each inevitable impurity is preferably 0.5% or less, and more preferably 0.1% or less. More specifically, the content of each of P, S, and N is preferably 0.01% or less, and the content of each of Fe, B, Ti, Cu, Nb, Mo, and Co is preferably 0.5% or less.

A composition of the Ni-based alloy powder of the present embodiment can be obtained by the following measurement method. As described in the examples mentioned later, powder for additive manufacturing after classification is dissolved in an appropriate aqueous solution, and this aqueous solution is analyzed by inductively coupled plasma (ICP), thereby measuring the content of a predetermined component. The content of each of C, N, and O can be obtained by gas analysis using a combustion method.

### (Hardness of Ni-Based Alloy Powder: 160 HV to 220 HV)

To prevent the particles from being crushed when the powder is spread, the hardness of the Ni-based alloy powder can be set to 160 HV or higher. On the other hand, if the hardness of the powder is excessively high, an additively manufactured product manufactured therefrom is likely to crack. Thus, an upper limit of the hardness can be set to 220 HV. The hardness is preferably 170 HV to 200 HV, and more preferably 180 HV to 190 HV.

### (Particle Size of Ni-Based Alloy Powder: 1 μm to 200 μm)

Additive manufacturing is a manufacturing method that forms a shape by repeatedly melting and solidifying individual powder particles. Since the requirements for alloy powder particle size differ depending on the additive manufacturing apparatus, a particle size range of the Ni-based alloy powder can be set to 1 μm to 200 μm in order to be applied in various manufacturing apparatuses.

For example, in the case of a powder bed fusion (PBF) method, if the Ni-based alloy powder has a particle size of less than 1 μm, the flowability decreases, making it difficult to obtain a sound additively manufactured product. On the other hand, if the Ni-based alloy powder has a particle size of exceeding 80 μm, a large layer thickness needs to be set and dimensional accuracy is reduced. Accordingly, the particle size range of the Ni-based alloy powder for the powder bed fusion method can be set to 1 μm to 80 μm. The particle size range is preferably 10 μm to 60 μm.

In the case of a directed energy deposition (DED) method, if the Ni-based alloy powder has a particle size of less than 1 μm, it is not possible to increase the supply amount, and the manufacturing speed is reduced. On the other hand, if the Ni-based alloy powder has a particle size of exceeding 200 μm, the volume required for a single melting and solidification process is excessively large, and undissolved remains are likely to occur. Accordingly, the particle size range of the Ni-based alloy powder for the directed energy deposition method can be set to 20 μm to 200 μm. The particle size range is preferably 40 μm to 120 μm.

It is preferable to use the powder obtained by a gas atomization method by which a spherical shape can be obtained. With respect to the particle size of the powder, a particle size distribution can be measured using a laser diffraction method (laser diffraction particle size distribution analyzer).

### (Particle Size Distribution of Ni-Based Alloy Powder)

In additive manufacturing, if the particle size of the powder is excessively small, a powder layer may be frayed or biased, resulting in poor coatability. On the other hand, if the particle size of the powder is excessively large, there is a risk that laser output may be insufficient and unmelted remains may occur. Accordingly, during manufacturing, defects may tend to increase or surface roughness may tend to be reduced. Hence, in a cumulative distribution curve indicating a relationship between particle size and volume cumulative from a small particle size side obtained by the laser diffraction method, a particle size d10 corresponding to a cumulative frequency of 10 volume % is preferably 10 μm or more and 25 μm or less, a particle size d50 corresponding to a cumulative frequency of 50 volume % is preferably 25 μm or more and 40 μm or less, and a particle size d90 corresponding to a cumulative frequency of 90 volume % is preferably 45 μm or more and 60 μm or less. Preferably, d10 is 15 μm or more and 20 μm or less, d50 is 30 μm or more and 35 μm or less, and d90 is 50 μm or more and 55 μm or less; more preferably, d10 is 18 μm or more and 20 μm or less, d50 is 32 μm or more and 34 μm or less, and d90 is 53 μm or more and 55 μm or less.

### (Uniformity of Ni-Based Alloy Powder: 0.8 to 1.2)

With respect to the particle size of the Ni-based alloy powder of the disclosure, a numerical value represented by (d90−d10)/d50 is defined as uniformity. As the uniformity becomes more than 1, spreadability tends to decrease; as the uniformity becomes less than 1, yield tends to decrease and productivity is reduced. Hence, the uniformity is preferably set in a range having a lower limit of 0.8 and an upper limit of 1.2. The range is preferably 0.90 to 1.15, and more preferably 0.95 to 1.10.

### (Angle of Repose of Ni-Based Alloy Powder: 40 Degrees or Less)

In additive manufacturing, it is preferable for a raw material powder to have good flowability in view of improving the spreadability. The flowability of the Ni-based alloy powder of the disclosure is evaluated according to an angle of repose in accordance with JIS R 9301-2-2. If the angle of repose exceeds 40 degrees, the flowability deteriorates and the spreadability is reduced. Thus, the angle of repose is preferably 40 degrees or less. A lower limit of the angle of repose is not particularly limited. The angle of repose is more preferably 35 degrees or less, and even more preferably 31 degrees or less.

The Ni-based alloy powder having the aforementioned angle of repose preferably has a flowability of 15 sec/50 g or more. The flowability is more preferably 18 sec/50 g or more, and even more preferably 19 sec/50 g or more.

### [Method for Manufacturing Alloy Powder]

As a method for manufacturing the Ni-based alloy powder (alloy powder), for example, a gas atomization method can be used. After a raw material powder blended to achieve a specified composition is dissolved in a crucible, a high-pressure gas is sprayed onto molten metal while the molten metal is taken out of the furnace from the bottom of the crucible. By solidifying the molten metal that has been dispersed as droplets due to the kinetic energy of a medium sprayed at a high pressure, Ni-based alloy powder of a spherical shape can be manufactured. The crucible used at this time is preferably made of Al₂O₃ in order to prevent the mixing of Zr impurities therein.

### [Method for Manufacturing Additively Manufactured Product]

A method for manufacturing an additively manufactured product of the disclosure is the following method for manufacturing an additively manufactured product. The method includes an additive manufacturing process that forms an additively manufactured product using Ni-based alloy powder. The Ni-based alloy powder contains, in terms of % by mass, 3.5% to 5.5% of Al, 0.8% to 4.0% of Cr, 0.02% to 0.06% of C, 1.0% to 1.8% of Si, 1.5% or less of Mn, and 0.001% to 0.050% of O, and a balance consisting of Ni and inevitable impurities, a content of Zr in the inevitable impurities being limited to 0.01% or less.

### (Additive Manufacturing Process)

An additive manufacturing method in the additive manufacturing process is not particularly limited. For example, by supplying the Ni-based alloy powder of the disclosure to an additive manufacturing apparatus based on the powder bed fusion (PBF) method, irradiating high energy such as a laser beam or electron beam onto an area where the powder is spread, and selectively fusing the alloy powder, a manufactured product of a desired shape can be additively manufactured. Depending on the shape of the additively manufactured product or the like, the additive manufacturing apparatus can be classified into being of the powder bed fusion (PBF) type and the directed energy deposition (DED) type. However, the additively manufactured product of the present embodiment can be manufactured by either method, and the type of the additive manufacturing apparatus or the like is not particularly limited.

### (Heat Treatment on Additively Manufactured Product)

In the method for manufacturing an additively manufactured product of the disclosure, a manufactured product produced by the additive manufacturing method may be subjected to a solution heat treatment for the purpose of removing residual stress and reducing microsegregation. A temperature in the case of performing the solution heat treatment is preferably 1000° C. or higher in order to dissolve microsegregation, and is preferably 1200° C. or lower as it needs to be lower than a solidus temperature. The temperature is more preferably 1050° C. or higher and 1180° C. or lower, and even more preferably 1100° C. or higher and 1160° C. or lower.

### [Additively Manufactured Product]

An additively manufactured product of the disclosure contains, in terms of % by mass, 3.5% to 5.5% of Al, 0.8% to 4.0% of Cr, 0.02% to 0.06% of C, 1.0% to 1.8% of Si, 1.5% or less of M n, and 0.001% to 0.050% of O, and a balance consisting of Ni and inevitable impurities, in which the content of Zr in the inevitable impurities is limited to 0.01% or less. The additively manufactured product has a defect rate of 0.1% or less and an oxidation amount per unit area of 0.005 mg/mm² or less, the oxidation amount per unit area being obtained by an oxidation test conducted for 950 hours in an atmospheric furnace at 800° C. and being represented by [mass loss before and after oxidation test]/[surface area before oxidation test]. The additively manufactured product has excellent high-temperature oxidation resistance due to the alumina coating film formed on the surface layer. The application of the additively manufactured product is not particularly limited. For example, it is possible to provide a member for a semiconductor manufacturing device that is composed of the additively manufactured product. The additively manufactured product has excellent high-temperature oxidation resistance particularly at 700° C. or higher, and an oxide film on the surface is less likely to grow even when the additively manufactured product is used in a high-temperature environment. Hence, when the additively manufactured product is applied in a member or component installed in an oxidation furnace for semiconductor manufacturing or a sintering furnace for manufacturing electronic components, or the like, it is difficult for an oxide to peel off from a surface of the member or component, thereby being effective for suppressing mixing of foreign matter into a product such as semiconductor or electronic component. An additively manufactured product having good high-temperature oxidation resistance and a complex shape can be provided not only in members for a semiconductor manufacturing device, but in a wide range of fields such as components in the aviation industry, space industry, automotive industry, chemical plants, pharmaceutical manufacturing facilities, and the energy field such as oil and gas.

(Oxidation Amount Per Unit Area of Additively Manufactured Product: 0.5 mg/cm² or Less)

The additively manufactured product of the disclosure has excellent high-temperature oxidation resistance. Here, the high-temperature oxidation resistance can be evaluated according to the oxidation amount per unit area represented by (Equation 1). In a high-temperature oxidation test conducted for 950 hours in an atmospheric furnace at 800° C., if the oxidation amount per unit area is 0.5 mg/cm² or less, the growth of the oxide film can be extremely suppressed. The oxidation amount per unit area is preferably 0.4 mg/cm² or less, and more preferably 0.3 mg/cm² or less.

[Oxidation amount per unit area (mg/cm²)]=[mass loss (mg) before and after oxidation test]/[surface area (cm²) before oxidation test] (Equation 1)

### (Defect Rate of Additively Manufactured Product: 0.1% or Less)

Since an internal defect of the additively manufactured product can become the origin of cracking, a low defect rate is desirable. The defect rate can be measured as an area ratio of a defective portion such as voids or unmelted powder. Details such as measurement conditions will be described later. A defect rate of 0.1% or less indicates that there are extremely few internal defects that can become the origin of cracking. Thus, the defect rate is set to 0.1% or less. The defect rate is preferably 0.05% or less, and more preferably 0.025% or less.

### (Hardness of Additively Manufactured Product: 210 HV to 300 HV)

It is desirable that the additively manufactured product of the disclosure has a high tensile strength. Accordingly, the hardness that is proportional to tensile strength is set to 210 HV or higher. On the other hand, from the viewpoint of maintaining machinability and preventing cracking, the upper limit of the hardness is set to 300 HV. The hardness preferably ranges from 240 HV to 290 HV, and more preferably from 260 HV to 280 HV. Details such as measurement conditions will be described later.

### EXAMPLES

In the following, examples of the disclosure will be described.

First, as an example, alloy powder (hereinafter also simply referred to as powder) a having a composition shown in Table 1 was prepared. As comparative examples, alloy powders b to e having compositions shown in Table 1 were prepared. A vacuum gas atomization method was used for a method for manufacturing the alloy powders. The raw material powders blended to achieve the specified compositions were dissolved using a high-frequency vacuum melting furnace, in which alloy powders a, c, and e were dissolved in a crucible made of Al₂O₃, and alloy powders b and d were dissolved in a crucible made of ZrO₂. Then, argon gas was ejected onto the molten metal poured from the bottom of the crucible, and the resultant was formed into fine grains and solidified in a cooling tower to obtain spherical powder. After that, the obtained powder was classified to obtain alloy powders a to e having a particle size range of 10 μm to 60 μm.

TABLE 1

| | Composition | | | | | | | | | | | | |
|---|---|---|---|---|---|---|---|---|---|---|---|---|---|
| Alloy | (mass %) | | | | | | | | | | | | |
| powder | Ni | Al | Cr | Si | Mn | Zr | Fe | C | O | N | B | P | S |
| a | Bal. | 3.99 | 2 | 1.33 | 0.44 | <0.01 | 0.01 | 0.036 | 0.0116 | 0.0002 | 0.0027 | 0.001 | 0.0002 |
| b | Bal. | 4.4 | 1.98 | 1.5 | — | 0.31 | — | 0.0055 | 0.0113 | 0.0002 | — | — | — |
| c | Bal. | 4.16 | 1.98 | 0.6 | 0.49 | <0.01 | 0.01 | 0.0065 | 0.0074 | 0.0003 | 0.0003 | 0.001 | 0.0002 |
| d | Bal. | 4.07 | 2.01 | 1.29 | — | 0.18 | 0.01 | 0.055 | 0.0049 | 0.0002 | 0.00092 | 0.001 | 0.0002 |
| e | Bal. | 6.06 | 2 | 1.33 | 0.44 | <0.01 | 0.01 | 0.034 | 0.0103 | 0.0002 | 0.0001 | 0.001 | 0.0003 |

The chemical compositions of these alloy powders shown in Table 1 were analyzed using, for example, inductively coupled plasma (ICP) emission spectroscopy. When comparing the compositions of the example powder and comparative example powders shown in Table 1, it can be seen that compared to powder a as the example, powder b had decreased C content and increased Zr content, powder c had decreased C and Si contents, powder d had increased Zr content, and powder e had increased Al content.

### [Evaluation of Properties of Ni-Based Alloy Powder]

Table 2 shows results of measurement of flowability, angle of repose, and hardness with respect to alloy powders a to e. The measurement methods and conditions are described below.

### (Evaluation of Particle Size and Flowability)

Each of the particle sizes d10, d50, and d90 was measured using a laser diffraction particle size distribution analyzer (Mastersizer 3000, manufactured by Malvern Panalytical). The uniformity represented by (d90−d10)/d50 was calculated using the measured d10, d50, and d90. The flowability of each powder was measured using a flowability meter (manufactured by Tsutsui Rikagaku Kikai) in accordance with JIS Z 2502.

### (Evaluation of Angle of Repose)

The angle of repose was measured using a multifunctional powder property measuring device (Multi Tester MT-02, manufactured by Seishin Enterprise). The measurement was performed in accordance with JIS R 9301-2-2. Specifically, the alloy powder was supplied to a receiving tray in the measuring device, and an angle of a formed mound was measured. At this time, a 355 μm sieve was used to supply the alloy powder.

### (Evaluation of Hardness)

After 1 g of the Ni-based alloy powder was filled into a 2 mm diameter hole, the alloy powder was embedded in resin using a vacuum device (CitoVac, manufactured by Struers) for cold mounting with resin. The alloy powder embedded in resin was polished with water-resistant emery paper up to #1500, then polished with diamond paste in the order of 1 μm and 0.3 μm particle sizes, and subjected to mirror finishing, thereby obtaining a test specimen for hardness evaluation.

With respect to a surface that underwent the mirror finishing, the Vickers hardness was measured using a micro Vickers hardness tester (FM-110, manufactured by Future-Tech). Specifically, a square pyramid diamond indenter was pressed into a total of 10 points on powder particles having a particle size of 30 μm to 40 μm, and held for 15 seconds with a test load of 25 gf. After that, a length of a diagonal of depressions left on the surface was measured to calculate the hardness, and an average value and standard deviation of the hardness at 10 points in each test specimen powder were obtained.

TABLE 2

| | Particle Size | | | | | | | |
|---|---|---|---|---|---|---|---|---|
| | Distribution | | | | | Angle of | Hardness | |
| Alloy | d10 | d50 | d90 | Flowability | | repose | (average value) | Standard |
| powder | (μm) | (μm) | (μm) | (sec/50 g) | Uniformity | Degree | HV | deviation |
| a | 18.8 | 32.6 | 54.0 | 19.3 | 1.08 | 30.1 | 184.63 | 6.92 |
| b | 17.3 | 30.7 | 51.4 | 18.9 | 1.11 | 28.2 | 193.94 | 16.78 |
| c | 18.2 | 32.4 | 54.5 | 19.5 | 1.12 | 30.2 | 163.10 | 10.92 |
| d | 17.7 | 32.9 | 57.2 | 20.8 | 1.20 | 30.9 | 190.20 | 10.75 |
| e | 18.5 | 31.8 | 52.5 | 21.4 | 1.07 | 31.0 | 257.07 | 12.55 |

Table 2 shows results of the evaluations of flowability, angle of repose, and hardness of powders a to e. When comparing the measurement results of the example and comparative examples, it can be seen that powder a satisfied both the particle size distribution and the uniformity within the aforementioned preferred ranges, and even more preferred ranges, which also relates to spreadability in terms of flowability.

On the other hand, when comparing the hardness of each powder shown in Table 2, it can be seen that powder c had lower hardness and powder e had higher hardness than powders a, b, and d. It is inferred that the decrease in Si content contributed to reduced powder hardness of powder c. It is inferred that the increase in Al content contributed to improved powder hardness of powder e. While there is no clear significant difference in hardness between powders a, b, and d, it can be said that powder a as the example provided relatively stable hardness from the fact that the hardness of powders b and d exhibited high standard deviation and large variation in measured values.

### [Evaluation of Properties of Additively Manufactured Product]

Additively manufactured products (hereinafter also simply referred to as manufactured products) A to E were produced respectively with respect to alloy powders a to e by an additive manufacturing apparatus (M 290, manufactured by EOS) based on selective laser melting (SLM) using laser as a heat source.

In the additive manufacturing conditions, each parameter included in the following (Equation 2) was set so that energy density would be 20 to 200 J/mm³. In the example, laser power was set to 300 W, scanning speed to 1000 mm/s, scanning pitch to 0.1 mm, and layer thickness to 0.04 mm, resulting in an energy density of 75 J/mm³.

[Energy density (J/mm³)]=[laser power (W)]/([scanning speed (mm/s)]×[scanning pitch (mm)]×[layer thickness (mm)]) (Equation 2)

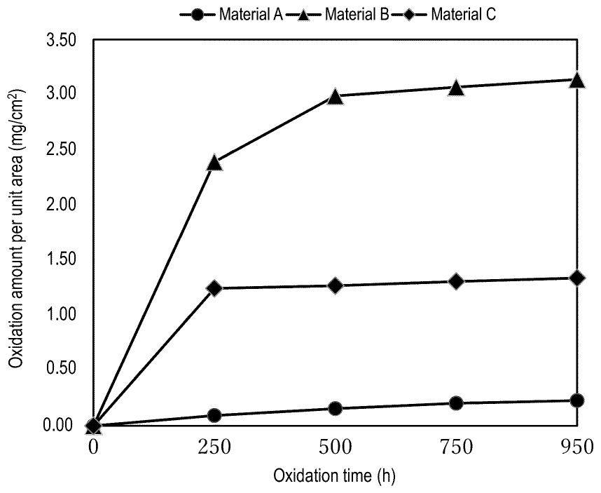

Additively manufactured products A to E were produced in the form of plate materials (25 mm×25 mm×5 mm) and block materials (10 mm×10 mm×10 mm). The defect rate and the hardness were evaluated with respect to additively manufactured products A to E, and the high-temperature oxidation resistance was further evaluated with respect to additively manufactured products A to C. The results are shown in Table 3 and FIG. 1. The measurement methods and conditions are described below.

### (Evaluation of Defect Rate)

Cross-sections of additively manufactured products A to E in the form of block materials (10 mm×10 mm×10 mm) were cut and embedded in resin using a vacuum device (CitoPress-30, manufactured by Struers) for hot mounting with resin. The additively manufactured product embedded in resin was polished with water-resistant emery paper up to #1500, then polished with diamond paste in the order of 1 μm and 0.3 μm particle sizes, and subjected to mirror finishing, thereby obtaining a test specimen for defect rate measurement.

With respect to the surface that underwent the mirror finishing, confirmation as to whether cracking had occurred and measurement of the defect rate were performed using a digital microscope (VHX-6000, manufactured by Keyence). In the case where fine cracks were observed, no evaluation of the defect rate was performed. Measurement areas for the defect rate included one place at the center of the surface that underwent the mirror finishing and four places approximately 1 mm away from the center toward the four corners. In each measurement area, a surface image of 1.58 mm×1.25 mm was acquired. Each acquired image was subjected to binarization, thereby obtaining voids or unmelted powder that appeared black, in which a portion having area of 0.18 μm² or more was identified as a defective portion. After that, an area ratio (defect rate) of the defective portion was calculated, and an average value and standard deviation of the defect rates at 5 points in each test specimen were obtained.

### (Evaluation of Hardness)

With respect to the surface that underwent the mirror finishing, the Vickers hardness was measured using a micro Vickers hardness tester (FM-110, manufactured by Future-Tech). Measurement areas included one place at the center of the surface that underwent the mirror finishing and four places approximately 1 mm away from the center toward the four corners. Specifically, a square pyramid diamond indenter was pressed, and held for 15 seconds with a test load of 25 gf. After that, a length of a diagonal of depressions left on the surface was measured to calculate the hardness, and an average value and standard deviation of the hardness at 5 points in each test specimen were obtained.

TABLE 3

| Additively | Hardness | | Defect rate | |
|---|---|---|---|---|
| manufactured | Average value | Standard | Average value | Standard |
| product | HV | deviation | Area % | deviation |
| A | 267.13 | 10.49 | 0.016 | 0.005 |
| B | 204.66 | 17.69 | Cracks occurred | |
| C | 209.73 | 8.08 | 0.026 | 0.019 |

| | | | |
|---|---|---|---|
| D | 221.45 | 9.43 | Cracks occurred |
| E | 314.41 | 6.73 | Cracks occurred |

Table 3 shows values of the hardness (HV) and the defect rate (area %) of the additively manufactured products. From the measurement results, it can be seen that manufactured products A, D, and E had higher hardness than manufactured products B and C. A possible factor is that manufactured products A, D, and E had a higher carbon content than manufactured products B and C.

It can be seen from the measurement results that manufactured products A and C had no fine cracks. Furthermore, manufactured product A had a defect rate of 0.016%, and manufactured product C had a defect rate of 0.026%. This result exhibited that both had a defect rate of 0.1% or less and were excellent as composition systems having high weld cracking susceptibility. This is because most of the defects in a composition system of a Zr-containing Ni-based corrosion-resistant alloy are originally cracks, and it is conceivable that the occurrence of cracking in both alloy powders a and c can be prevented by limiting the Zr content to a low value of 0.01% or less. On the other hand, a large number of cracks occurred in manufactured products B, D, and E. A possible reason is that the Zr content in manufactured products B and D was high, and the Al content in manufactured product E was excessive. It can be confirmed that manufactured products A and C actually had high internal density as additively manufactured products and exhibited excellent additive manufacturability. However, manufactured product C exhibited low hardness, and there is a concern of reducing the tensile strength of the manufactured product. With respect to manufactured products B, D, and E, the defect rate was unable to be calculated due to the occurrence of a large number of cracks.

### (Evaluation of High-Temperature Oxidation Resistance)

To evaluate the high-temperature oxidation resistance of manufactured products A and C in which no cracks occurred in the aforementioned defect evaluation, as-built materials, which remained unchanged after additive manufacturing, were prepared with respect to manufactured products A and C in the form of plate materials. For comparison, an as-built material of manufactured product B was prepared as an example of a sample in which cracks occurred. Surfaces of these plate materials were polished with water-resistant emery paper up to #400, followed by electrolytic polishing. After electrolytic polishing, each plate material was degreased by being held in acetone under ultrasonic vibration for 5 minutes, and a high-temperature oxidation resistance test specimen was obtained.

After measurement for mass, each test specimen was held at 800° C. using a small atmospheric furnace, with an oxidation time set in four stages: 250 hours, 500 hours, 750 hours, and 950 hours. After cooling to room temperature, a mass change amount of the test specimen was measured at each stage. With respect to each test specimen, the oxidation amount per unit area (mg/cm²) was calculated using the aforementioned (Equation 1). The measurement results are shown in FIG. 1.

From the results of the high-temperature oxidation resistance test shown in FIG. 1, the oxidation amount per unit area of manufactured product A was kept at 0.23 mg/cm² after 950 hours. On the other hand, manufactured product B had an oxidation amount per unit area of 3.14 mg/cm², and manufactured product C had an oxidation amount per unit area of 1.34 mg/cm², indicating a significant increase in oxidation amount. It can be confirmed that manufactured product A had extremely excellent high-temperature oxidation resistance from the fact that the oxidation amount per unit area was suppressed over a long period. A possible reason is that an alumina coating film formed on a surface of manufactured product A was stable since alloy powder a contained more Si than alloy powder c, and further oxidation was suppressed. On the other hand, in manufactured product B, it is conceivable that the high-temperature oxidation resistance deteriorated due to the following reason. That is, since alloy powder b contained more Zr than alloy powders a and c, a Zr oxide was formed and formation of an alumina coating film on the surface was inhibited.

From the above test results, the following can be confirmed. Compared to alloy powders b to e as comparative examples, alloy powder a as an example of the Ni-based alloy powder for additive manufacturing of the disclosure had a composition excellent in high-temperature oxidation resistance and low in weld cracking susceptibility, as well as suitable flowability and hardness for defect suppression or spreadability during additive manufacturing. With respect to an additively manufactured product produced using alloy powder a, it can be confirmed that, compared to manufactured products B to E as comparative examples, manufactured product A as an example was excellent in any of hardness, defect rate, and high-temperature oxidation resistance.

1. A Ni-based alloy powder for additive manufacturing, containing, in terms of % by mass,
Al: 3.5% to 5.5%,
Cr: 0.8% to 4.0%,
C: 0.02% to 0.06%,
Si: 1.0% to 1.8%,
Mn: 1.5% or less, and
O: 0.001% to 0.050%,
and a balance consisting of Ni and inevitable impurities, wherein a content of Zr in the inevitable impurities is limited to 0.01% or less.

2. The Ni-based alloy powder for additive manufacturing according to claim 1, containing, in terms of % by mass,
Al: 3.6% to 5.0%,
Cr: 1.5% to 3.0%,
C: 0.03% to 0.05%,
Si: 1.2% to 1.5%,
Mn: 0.2% to 1.0%, and
O: 0.008% to 0.030%.

3. The Ni-based alloy powder for additive manufacturing according to claim 1, having a Vickers hardness ranging from 160 HV to 220 HV.

4. The Ni-based alloy powder for additive manufacturing according to claim 1, wherein,
in a cumulative distribution curve indicating a relationship between particle size and volume cumulative from a small particle size side obtained by a laser diffraction method, a particle size d10 corresponding to a cumulative frequency of 10 volume % is 10 μm or more and 25 μm or less, a particle size d50 corresponding to a cumulative frequency of 50 volume % is 25 μm or more and 40 μm or less, and a particle size d90 corresponding to a cumulative frequency of 90 volume % is 45 μm or more and 60 μm or less.

5. The Ni-based alloy powder for additive manufacturing according to claim 4, wherein a uniformity represented by (d90−d10)/d50 ranges from 0.8 to 1.2.

6. The Ni-based alloy powder for additive manufacturing according to claim 1, wherein an angle of repose measured in accordance with JIS R 9301-2-2 is 40 degrees or less.

7. A method for manufacturing an additively manufactured product, comprising an additive manufacturing process that forms an additively manufactured product using Ni-based alloy powder, wherein the Ni-based alloy powder contains, in terms of % by mass,
Al: 3.5% to 5.5%,
Cr: 0.8% to 4.0%,
C: 0.02% to 0.06%,
Si: 1.0% to 1.8%,
Mn: 1.5% or less, and
O: 0.001% to 0.050%,
and a balance consisting of Ni and inevitable impurities, a content of Zr in the inevitable impurities being limited to 0.01% or less.

8. An additively manufactured product, containing, in terms of % by mass,
Al: 3.5% to 5.5%,
Cr: 0.8% to 4.0%,
C: 0.02% to 0.06%,
Si: 1.0% to 1.8%,
Mn: 1.5% or less, and
O: 0.001% to 0.050%,
and a balance consisting of Ni and inevitable impurities, a content of Zr in the inevitable impurities being limited to 0.01% or less, wherein
the additively manufactured product has a defect rate of 0.1% or less and an oxidation amount per unit area of 0.005 mg/mm² or less, the oxidation amount per unit area being obtained by an oxidation test conducted for 950 hours in an atmospheric furnace at 800° C. and being represented by [mass loss before and after oxidation test]/[surface area before oxidation test].

9. The additively manufactured product according to claim 8, having a Vickers hardness ranging from 210 HV to 300 HV.
